(19) United States
(12) Patent Application Publication
(10) Pub. No.: US 2021/0374162 A1
(43) Pub. Date: Dec. 2, 2021

(54) METHODS AND SYSTEMS FOR STREAMLINED SEARCHING ACCORDING TO SEMANTIC SIMILARITY

(71) Applicant: Netflix, Inc., Los Gatos, CA (US)

(72) Inventors: Stanislav Kirdey, San Jose, CA (US); F. William High, Los Angeles, CA (US)

(21) Appl. No.: 17/230,587

(22) Filed: Apr. 14, 2021

Related U.S. Application Data
(60) Provisional application No. 63/030,666, filed on May 27, 2020.

(51) Int. Cl. G06F 16/28; G06F 16/2458; G06F 16/215; G06N 3/08

(52) U.S. Cl. CPC G06F 16/285; G06F 16/288; G06N 3/08; G06F 16/215; G06F 16/2477

(57) ABSTRACT

The disclosed computer-implemented method may include accessing various portions of data, accessing (or generating) neural embeddings for that data. The neural embeddings may be configured to encode semantic information associated with the accessed data into numeric values. The method may also include applying locality sensitive hashing to the accessed neural embeddings to assign data portions encoded within a specified numerical range to a cluster of related data items, and to assign data portions outside of the specified numerical range to a cluster of unrelated data items. Still further, the method may include performing at least one data management operation on the accessed data according to the clustering resulting from the locality sensitive hashing. Various other methods, systems, and computer-readable media are also disclosed.

### CROSS REFERENCE TO RELATED APPLICATION

This application claims the benefit of U.S. Provisional Application No. 63/030,666, filed 27 May 2020, the disclosure of which is incorporated, in its entirety, by this reference.

### BACKGROUND

Many entities, including media distribution systems, generate large log files during operation (e.g., 5-10+GB). When system engineers, developers, or other users attempt to search through the log data for bugs or for other anomalies, those users typically implement traditional search algorithms. These types of search algorithms are designed to sift through the data line by line, searching for specific keywords, terms, or other specific items. In a log file that is multiple gigabytes in size (or larger), that searching can take many hours. As such, in large entities that generate many such log files each day, the amount of time and resources spent performing searches and other operations on the log files may become burdensome. This may, in turn, increase the cost of providing the media distribution service or other type of service provided by the entity.

### SUMMARY

As will be described in greater detail below, the present disclosure describes methods and systems that facilitate data management operations including performing semantic similarity searches using neural embeddings. These neural embeddings, in combination with locality sensitive hashing (LSH), provide mechanisms that allow for much faster searching, and further provide improvements to other operations including diff operations, deduplication operations, exception monitoring, and other data management operations.

In one example, a computer-implemented method may include accessing various portions of data, and accessing (or generating) neural embeddings for that data. The neural embeddings may be configured to encode semantic information associated with the accessed data into numeric values. The method may also include applying locality sensitive hashing to the accessed neural embeddings to assign data portions encoded within a specified numerical range to a cluster of related data items, and to assign data portions outside of the specified numerical range to a cluster of unrelated data items. Still further, the method may include performing at least one data management operation on the accessed data according to the clustering resulting from the locality sensitive hashing.

In some examples, the data management operation may include a diff operation that identifies differences in the various portions of data. In some cases, the data may include log files. In such cases, the diff operation is performed on the log files (e.g., two different versions of the same log file). The log files may include multiple different words or phrases. The neural embeddings encode semantic information associated with the words or phrases into a numerical representation associated with each word or phrase of the log file.

In some embodiments, the data management operation may include a semantic search operation that searches the various portions of data for specified data. The search operation may be performed using the clustering resulting from the locality sensitive hashing. As such, at least in some cases, data items in the cluster of related data items may be searched prior to searching data items in the cluster of unrelated data items. In some examples, the data management operation may include performing a substantially constant time semantic search on a dataset of at least a threshold minimum size.

In some examples, the data management operation may include a deduplication operation that removes duplicate information from the accessed data. The deduplication operation may be performed using the clustering resulting from the locality sensitive hashing. Accordingly, at least in some cases, data items in the cluster of related data items may be removed, and data items in the cluster of unrelated data items may be maintained.

In some cases, the various portions of accessed data may include image data, video data, audio data, or textual data. In some examples, the above-described method may further include generating the neural embeddings that are accessed for the subsequent application of locality sensitive hashing. In some examples, the neural embeddings may be generated by a communicatively linked neural network.

In addition, a corresponding system may include several modules stored in memory that perform steps including accessing portions of data, and accessing neural embeddings, where the neural embeddings are configured to encode semantic information associated with the accessed data into numeric values. The modules may further apply locality sensitive hashing to the accessed neural embeddings to assign data portions encoded within a specified numerical range to a cluster of related data items, and to assign data portions outside of the specified numerical range to a cluster of unrelated data items. The modules may also perform at least one data management operation on the accessed data according to the clustering resulting from the locality sensitive hashing.

In some embodiments, the data management operation may include exception monitoring, which is configured to monitor for and identify anomalous occurrences or exceptions. In some cases, the exception monitoring may be performed using the clustering resulting from the locality sensitive hashing, such that data items in the cluster of unrelated data items are identified as potential exceptions.

In some examples, the data management operation may include event detection, which determines when specified events have occurred. In some cases, the event detection may be performed using the clustering resulting from the locality sensitive hashing, such that data items in the cluster of related data items are grouped together as part of a specified event.

In some embodiments, the data management operation performed on the accessed data may include updating a neural embedding model used to generate the neural embeddings. In some cases, the embedding model is continually updated over time based on feedback derived from the locality sensitive hashing clustering.

In some embodiments, the above-described method may be encoded as computer-readable instructions on a computer-readable medium. For example, a computer-readable medium may include one or more computer-executable instructions that, when executed by at least one processor of a computing device, may cause the computing device to access portions of data, and access neural embeddings, where the neural embeddings are configured to encode semantic information associated with the accessed data into numeric values. The instructions may further apply locality sensitive hashing to the accessed neural embeddings to assign data portions encoded within a specified numerical range to a cluster of related data items, and to assign data portions outside of the specified numerical range to a cluster of unrelated data items. The instructions may also perform at least one data management operation on the accessed data according to the clustering resulting from the locality sensitive hashing.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a computing environment in which embodiments described herein may operate.

FIG. 2 is a flow diagram of an exemplary method for facilitating data management operations including semantic similarity search using neural embeddings.

FIG. 3 illustrates an embodiment in which different data management operations are outlined.

FIG. 4 illustrates a computing environment in which neural embeddings are generated for log files and are implemented to perform a diff operation.

FIG. 5 illustrates an embodiment in which different types of input data are presented.

FIG. 6 illustrates a computing environment in which neural embeddings are generated for many different types of input data and are implemented to perform different data management operations.

FIG. 7 illustrates an embodiment in which a neural network and associated modules are implemented to generate neural embeddings.

FIG. 8 is a block diagram of an exemplary content distribution ecosystem.

FIG. 9 is a block diagram of an exemplary distribution infrastructure within the content distribution ecosystem shown in FIG. 8.

FIG. 10 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to methods and systems that facilitate data management operations including performing semantic similarity searches using neural embeddings. As noted above, many organizations generate log files or other types of large data files that may include text, audio, video, and/or other data. These data files may be tens or hundreds of gigabytes, or larger. Performing substantially any type of operation on files this large is cumbersome and may take great deal of processing time. For example, performing a diff operation on two different versions of a log file that is 10 GB in size may take many hours to finish. Other data management operations may take a similar amount of time or even longer. For instance, performing semantic search operations, deduplication operations, exception monitoring, event detection, or other operations may each take many hours on very large files.

Furthermore, current algorithms are often complex in nature, and may themselves encompass many thousands of lines of code. Previous attempts at searching documents for semantically similar terms, for example, included generating a “k-hot bag of words.” In a “k-hot bag of words” encoding, each word of the document is parsed, and the total number of appearances of each word is noted. For example, in the sentence “log in error, check log,” the following would be stored: {“log”: 2, “in”: 1, “error”: 1, “check”: 1}, indicating that there were two instances of the word “log,” one instance of the word “in,” etc. In other cases, the encoding might be represented as a vector where the associated index corresponds to a word and the value is used as the count. Here, the sentence “log in error, check log” may be presented as a vector, where the first entry is reserved for “log” word counts, the second for “in” word counts, and so forth: [2, 1, 1, 1, 0, 0, 0, 0, 0, . . . ]. Such a vector may include multiple zeros representing the other words in the dictionary (each slot being referred to as a “dimension” in the vector). These vectors containing large numbers of zeros, however, result in wasted storage resources. Still further, the k-hot bag of words approach does not allow for fuzzy diff operations, where sentences with semantically similar meanings (e.g., “problem authenticating” would not be matched to the phrase “log in error” in a diff or a search operation.

As will be explained in greater detail below, embodiments of the present disclosure may implement a combination of Locality Sensitive Hashing (LSH) and Neural Networks (NN) to perform many different types of operations including identifying known errors as well as, potentially, unknown errors (e.g., using fuzzy search). The embodiments herein may create neural embeddings that encode semantic information in words and sentences, and then implement LSH to efficiently assign approximately nearby items to the same vectors, while assigning faraway items to different vectors. The neural networks used in the embodiments described herein may access the structured and unstructured data in a log and create vectors that identify individual words, noting how many times each word appeared. LSH may then be used to determine which words are semantically similar using dimensionality reduction to place semantically similar words and sentences near to each other in a specified vector space (i.e., in a neural embedding). The systems herein may then insert each log line into a low dimensional vector and, optionally, may fine-tune or update the neural embedding model at the same time.

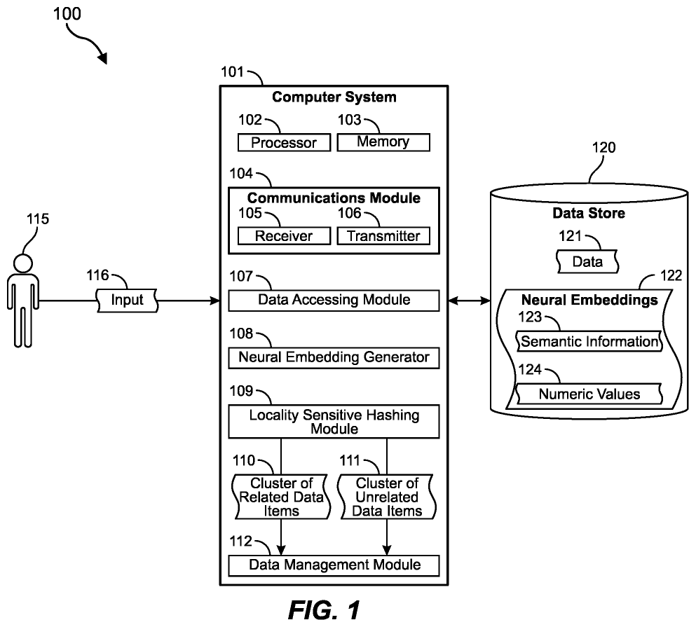

Still further, the embodiments herein may further assign the vector to a cluster, and may identify lines in different clusters as “different.” This “diff” operation thus compares the logs of a current build to the logs of a previous, successful build, focusing on new bugs or changes in the current build. This process may implement far less underlying code than previous solutions (e.g., potentially only 100 lines of code (e.g., Python code) or less). And while using less software code, the process may return search results a full order of magnitude (or more) faster than previous solutions or algorithms. These embodiments will be explained in greater detail below with regard to FIGS. 1-10.

FIG. 1 illustrates a computing environment 100 that includes a computer system 101. The computer system 101 may include software modules, embedded hardware components such as processors, or includes a combination of hardware and software. The computer system 101 may include substantially any type of computing system including a local computing system or a distributed (e.g., cloud) computing system. In some cases, the computer system 101 includes at least one processor 102 and at least some system memory 103. The computer system 101 includes program modules for performing a variety of different functions. The program modules may be hardware-based, software-based, or include a combination of hardware and software. Each program module may use computing hardware and/or software to perform specified functions, including those described herein below.

The computer system 101 may include a communications module 104 that is configured to communicate with other computer systems. The communications module 104 may include any wired or wireless communication means that can receive and/or transmit data to or from other computer systems. These communication means include hardware interfaces including Ethernet adapters, WIFI adapters, hardware radios including, for example, a hardware-based receiver 105, a hardware-based transmitter 106, or a combined hardware-based transceiver capable of both receiving and transmitting data. The radios are cellular radios, Bluetooth radios, global positioning system (GPS) radios, or other types of radios. The communications module 104 may be configured to interact with databases, mobile computing devices (such as mobile phones or tablets), embedded or other types of computing systems.

The computer system 101 may also include a data accessing module 107. The data accessing module 107 may be configured to access data from a data store (e.g., data store 120). The data store 120 may be substantially any type of local or distributed data store including a cloud-based data store. The data accessing module 107 may access data 121 from the data store on demand over a wired or wireless network connection. The data 121 may include substantially any type of data including textual data (e.g., log files, scripts, word processing documents, spreadsheet documents, etc.), image data from still images or from moving images (e.g., video clips or movies), audio data from audio files in various formats, database information, web page data, database blobs, or other types of data. In some cases, the data accessing module 107 may also be configured to access neural embeddings 122. In cases where the neural embeddings are generated by another computer system or another entity, the data accessing module 107 may access one or more of these previously generated neural embeddings 122. The neural embeddings 122 are data structures that are configured to associate a semantic meaning or other semantic information 123 with a numerical value 124.

For example, in the case of text, neural embeddings 122 may associate semantic meaning associated with words or phrases to numerical values 124. Thus, words or phrases that have a similar semantic meaning may have a similar assigned numerical value and, correspondingly, words or phrases that have different semantic meanings may have dissimilar assigned numerical values 124. Images and video may also be analyzed and broken down into vectors or other data structures where different portions of the data structure may have semantic similarities or dissimilarities. Those portions of the image or video that are semantically similar may have similar numeric values in the neural embeddings 122, while those portions that are semantically different will have different numeric values. Similar principles may be applied to audio files, database files, text files, or other data. The neural embedding generator 108 of computer system 101 may generate these neural embeddings 122, or another entity may generate the embeddings. These neural embeddings 122 may be stored in data store 120 and may be accessed by the data accessing module 107. In some specific cases, the neural embeddings are stored as vectors (e.g., as a 10-dimensional vector).

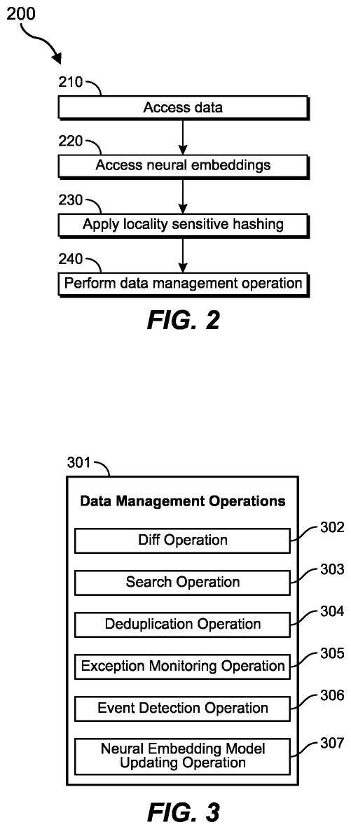

The locality sensitive hashing (LSH) module 109 of computer system 101 may be configured to take the neural embeddings 122 and apply LSH to cluster related items together. This may result in different numbers and different types of clusters. For simplicity's sake, in FIG. 1, the LSH module 109 generates two clusters: a cluster of related items 110 and a cluster of unrelated items 111. These clusters of data items 110/111 may be provided to a data management module 112. The data management module 112 may be configured to perform various data management operations using the clusters of data items 110/111 generated by the LSH module 109. For example, the data management module 112 may be configured to perform a diff operation on a text file (e.g., a log file or script). Or, the data management module 112 may be configured to perform a search operation on an audio file, or perform a deduplication operation on an operations log, or perform an exception monitoring operation, or an event detection operation, a model updating operation, or other data management operation. Each of these operations and embodiments will be described in greater detail below with regard to method 200 of FIG. 2 and FIGS. 3-10. Any or all of these embodiments may be controlled or informed by input 116 provided by a user 115 such as an administrator, a developer, an information technology (IT) worker, or other user.

FIG. 2 is a flow diagram of an exemplary computer-implemented method 200 for implementing neural embeddings and locality sensitive hashing to perform data management operations. The steps shown in FIG. 2 may be performed by any suitable computer-executable code and/or computing system, including the system illustrated in FIG. 1. In one example, each of the steps shown in FIG. 2 may represent an algorithm whose structure includes and/or is represented by multiple sub-steps, examples of which will be provided in greater detail below.

As illustrated in FIG. 2, at step 210, the data accessing module 107 of FIG. 1 may access various portions of data 121. At step 220, the data accessing module 107 may access neural embeddings 122 that correspond to the data 121. As noted above, the neural embeddings 122 may be configured to encode semantic information 123 associated with the accessed data 121 into numeric values 124. In some cases, encoding semantic information in this manner may allow seemingly dissimilar items to be grouped together based on semantic meaning. At step 230, the method 200 may next include applying locality sensitive hashing to the accessed neural embeddings to assign data portions encoded within a specified numerical range to a cluster of related data items 110, and to assign data portions outside of the specified numerical range to a cluster of unrelated data items 111. Still further, at step 240, the method 200 may include performing at least one data management operation on the accessed data 121 according to the clustering resulting from the locality sensitive hashing.

In some cases, the computer system 101 (or a collection of computer systems) may deal with hundreds of thousands of requests each second (or more). These requests may involve data management operations including exception monitoring, log processing, and stream processing. The embodiments herein, including the method 200 of FIG. 2, may be performed at scale to accommodate these large numbers of requests each second. Moreover, the embodiments herein may implement natural language processing (NLP) to decipher the meaning of underlying words or phrases in a document. Being able to scale these NLP implementations allows the computer systems described herein to use applied machine learning in telemetry and logging spaces. The scalability provided by the embodiments described herein allows businesses and other entities to provide data management operations including text deduplication, semantic similarity search, and textual outlier detection in real-time.

For example, the diff implementation described herein (e.g., performing a diff operation 302 in FIG. 3) may involve embedding each line of text into a low dimensional vector and, in some cases, “fine-tuning” or updating the neural embedding model used to generate the neural embeddings at the same time. The diff implementation may then assign the vector to a cluster, identifying text lines in different clusters as “different.” Locality sensitive hashing may provide a probabilistic algorithm that permits constant time cluster assignment and near-constant time nearest neighbors search. LSH may, in the embodiments herein, map a vector representation to a scalar number, or more precisely a collection of scalars. While standard hashing algorithms (e.g., MD5) aim to avoid collisions between any two inputs that are not the same, LSH aims to avoid collisions if the inputs are far apart and, at the same time, promote collisions if the inputs are different but near to each other in the vector space.

In one example, the embedding vector for the phrase “log in error, check log” may be mapped to binary number 01—and 01 then represents the cluster. The embedding vector for the phrase “problem authenticating” would be, with high probability, mapped to the same binary number, 01. In this manner, LSH may enable fuzzy matching, as well as the inverse problem, fuzzing diffing. The embodiments described herein thus apply LSH to embedding spaces to achieve the desired clustering. This clustering is then used when performing different types of data management operations 301, as outlined in FIG. 3.

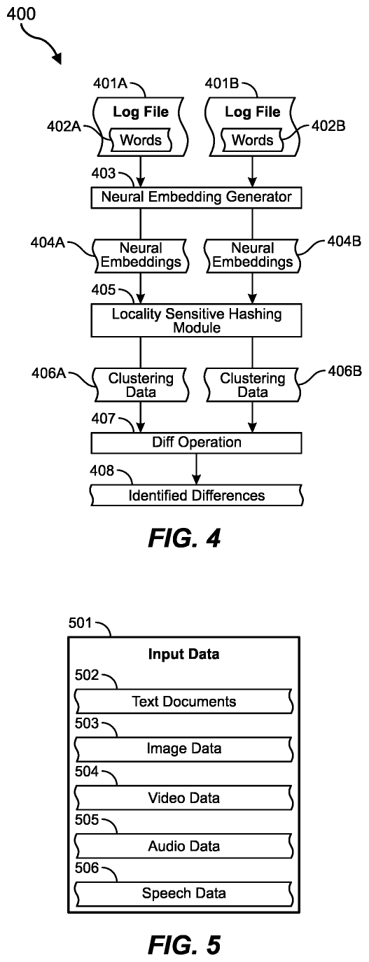

In some examples, for instance, the data management operation performed by the data management module 112 of FIG. 1 may include a diff operation 302. The diff operation may be configured to identify differences in the accessed data 121. In some cases, the data may include log files. In such cases, the diff operation 302 is performed on the log files. The log files may include multiple different words or phrases. For example, as shown in FIG. 4, two different versions of a log file may be accessed, 401A and 401B. Each version of the log file may include different words 402A/402B, phrases, or sentences. The neural embedding generator 403 may be configured to generate neural embeddings for each version of the log file, resulting in neural embeddings 404A and 404B, respectively. The neural embeddings may encode semantic information associated with the words or phrases into a numerical representation associated with each word or phrase for each version of the log file. The locality sensitive hashing module 405 may then perform LSH on the neural embeddings 404A and 404B, resulting in respective clustering data 406A and 406B. The diff operation 407 may then be performed on the two versions of the log file to identify differences 408 between the two versions of the log file 401A/401B. These differences may then be presented to a user or other entity on an electronic device or display.

While two versions of a file are used in this example, it will be noted that a diff may be performed between different files or multiple versions of the same file. Because the words and phrases of the log file have been assigned numerical values as part of the neural embedding process, and have been clustered together as part of the LSH process, the amount of time performing the diff operation 407 may be greatly reduced, when compared to traditional MD5 or other hashing algorithms. Indeed, in some cases, the amount of time performing the diff operation 407 may be orders of magnitude shorter than when using common hashing algorithms. The combination of neural embeddings and LSH produces unexpected results that offer much faster processing times than existing solutions.

These diff operations and other data management operations (e.g., 301 of FIG. 3, including search 303, deduplication 304, exception monitoring 305, event detection 306, neural embedding model updating 307, or other operations) may also be performed on other types of data. As shown in FIG. 5, for example, a diff operation, a search operation, or other operations may be performed on many different types of input data 501 including text documents 502 (e.g., scripts, log files, etc.), image data 503 (bitmap data, compressed image data such as jpeg files, uncompressed, raw image data, etc.), video data 504 (compressed such as mpeg files, or uncompressed), audio data 505 (compressed such as mp3 files, or uncompressed), speech data 506, or other types of data. In some cases, the data is first converted to vectors (e.g., in the case of image or video data). In some examples, for instance, a diff operation may be performed on image or audio data. In such cases, the systems herein may access the image or audio data and generate neural embeddings for that data. The neural embeddings may assign numerical values to certain portions of an image, or to certain portions of an audio file. These neural embeddings may then be grouped or clustered using LSH in the above-described manner. The diff (other data management) operation may then be performed using the clustered data. Such diff embodiments may allow the systems herein to quickly identify whether one image is the same as another image, or whether one audio file is the same as another audio file, or whether one video is the same as another. Such embodiments may be used, for example, to identify copyrighted material hosted on the internet.

Search operations may use the LSH clustered data to quickly find specified audio, video, text, or other documents or files. In some cases, for example, data items in a cluster of related data items may be searched prior to searching data items in the cluster of unrelated data items. In this manner, the clustering may reduce the overall amount of data that needs to be searched to find a sought result. This reduction in data that is to be searched thus reduces the amount of time spent on the search, returning results in a much faster manner. In some cases, the search operation may include performing a substantially constant time semantic search on a dataset of at least a threshold minimum size. Thus, for instance, a user may specify a dataset of at least 5 GB. The search operation 303 may include a substantially constant time semantic search on the dataset using LSH clustering resulting from clustered neural embeddings. The constant time semantic search may be facilitated by locality sensitive hashing, which, as noted above, is a probabilistic algorithm that permits constant time cluster assignment and near-constant time nearest neighbor search.

In a similar manner, LSH clustered data may be used to identify speech patterns in speech data 506. Diff or other data management operations may be performed on the speech data 506 to determine which sounds are part of which words, and maintain a database of sounds that can be referenced when attempting to perform natural language processing. The LSH clustered data may thus be used to identify words or phrases spoken by a user, and may improve over time as different sounds are compared against each other and are associated with known words or phrases.

The data management operations 301 may also include a deduplication operation 304. The deduplication operation 304 may be configured to remove duplicate information from various portions of accessed data (e.g., data 121 of FIG. 1). The deduplication operation 304 may be performed using the clustering resulting from the locality sensitive hashing that was performed on neural embeddings 122 associated with the data 121. In such cases, with the data being clustered into clusters of related data items 110 and clusters of unrelated data items 111, those data items that are part of the cluster of related data items 110 may be removed in the deduplication operation 304, and data items in the cluster of unrelated data items 111 may be maintained. Accordingly, the combination of neural embeddings and LSH may be used to perform deduplication operations. The deduplication may be performed on full or partial documents, and may be performed on various types of input data including any or all of the input data types 501 of FIG. 5.

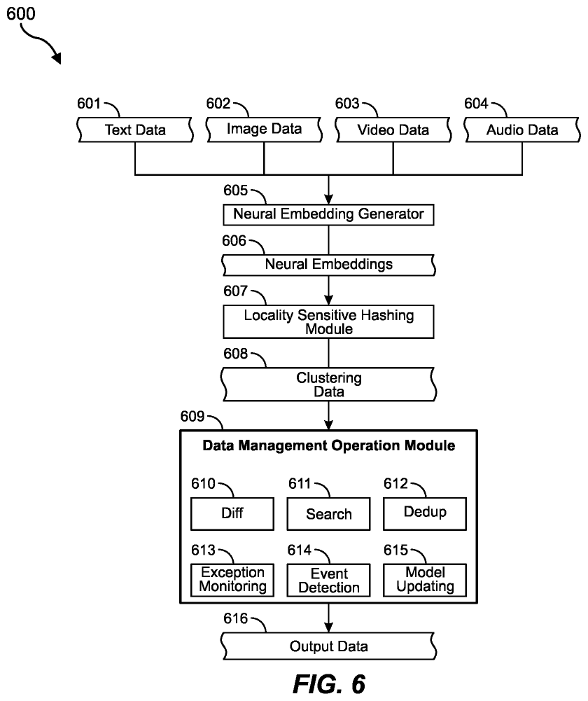

In some embodiments, as noted above, the neural embeddings 122 may be generated by another entity or computer system. In other cases, the neural embeddings 122 may be generated by the computer system 101 (or by a module thereof). In some cases, as shown in computing environment 600 of FIG. 6, a neural embedding generator 605 may receive or access various types of data (e.g., text data 601, image data 602, video data 603, audio data 604, or other types of data) and may generate neural embeddings 606 associated with the accessed data. The neural embeddings 606 are then subject to the application of locality sensitive hashing by locality sensitive hashing module 607. The locality sensitive hashing module 607, upon performing locality sensitive hashing data on the generated neural embeddings 606, may then provide the resulting clustering data 608 to a data management operation module 609. This data management operation module 609 may perform various operations on the clustering data 608, including diffs 610, searches 611, deduplication operations 612, exception monitoring 613, event detection 614, model updating 615, or other operations. The output data 616 resulting from these data management operations may then be provided to various entities, users, and/or computer systems. In some cases, the neural embedding generator 605 may be part of, or may itself be, a neural network. This neural network may be communicatively linked to computer system 101 of FIG. 1, for example, and may provide the generated neural embeddings 606 to the computer system 101 and/or to other systems.

In some embodiments, the data management operation module 609 may perform exception monitoring using the LSH-clustered data. The exception monitoring operation 613 may be configured to monitor for and identify anomalous occurrences. For instance, in a media streaming embodiment, a media streaming entity may be performing many different computer- and network-based tasks in order to provide streaming media over a wired or wireless network connection. During this process, many of the computer- and network-based tasks may throw exceptions during operation. These exceptions may occur rarely or frequently. In some cases, frequently occurring exceptions may happen multiple times each minute or even multiple times each second. In such cases, the list of exceptions may grow very large very quickly. The embodiments herein may be configured to generate neural embeddings 606 for the exceptions according to their underlying semantic meaning. The locality sensitive hashing module 607 may then perform LSH on the generated neural embeddings 606, resulting in clustering data 608. This clustering data 608 may group certain exceptions together. As such, data items grouped into a cluster of unrelated data items may be identified as potential exceptions, while data items grouped into a cluster of related items may be omitted from the list of exceptions.

In still other cases, the data management operation module 609 may include event detection 614. The event detection operation 614 may be configured to determine when specified events (e.g., software bugs or errors) have occurred. In some cases, for example, the user 115 of FIG. 1 may provide, via input 116, an indication of which events are to be detected or otherwise identified. The event detection operation 614 may use the clustering data 608 resulting from the locality sensitive hashing (e.g., performed by module 607) and, as such, data items in a cluster of related data items may be grouped together as belonging to or as being part of a specified event. Detectable events may include substantially any computer-based, network-based, or software code-based events. In at least some embodiments, the data management operation module 609 may be configured to detect the occurrence (or non-occurrence) of specified events in real-time. When such events occur, the output data 616 may be provided to the user 115 and/or to other users or entities.

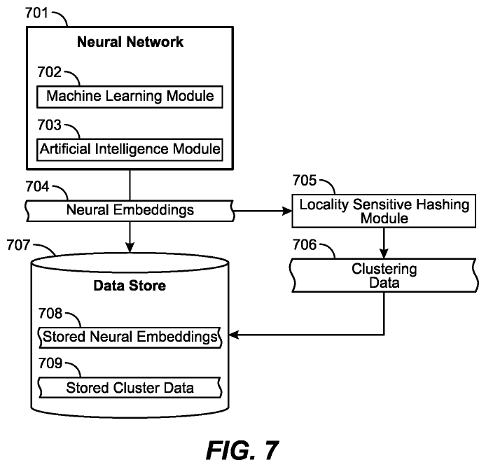

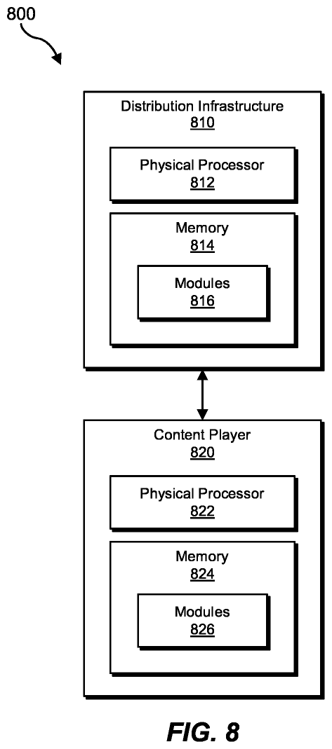

In some embodiments, the data management operation module 609 of FIG. 6 may update a neural embedding model as part of its data management operations. For instance, the data management operation module 609 may perform a model updating operation 615 on a neural embedding model to apply one or more updates to the neural embedding model (e.g., 605 of FIG. 6). In some cases, the embedding model may be continually updated over time based on feedback derived from the locality sensitive hashing clustering. The clustering may inform the neural embedding model how to better associate numerical values based on the semantic meaning of the underlying data. FIG. 7 illustrates an embodiment in which a neural network 701 implements a machine learning module 702, an artificial intelligence module 703, or other similar modules to generate updates for the neural embedding model used to generate the neural embeddings 704. The updates may be applied in real time, as the neural embedding model is used to generate neural embeddings. The neural network 701 may pass the neural embeddings 704 to a locality sensitive hashing module 705, which clusters the neural embeddings into resulting clustering data 706, and/or to a data store 707, where the neural embeddings 708 and cluster data 709 may be stored for future retrieval. In some cases, the stored neural embeddings 708 and/or cluster data 709 may be used as feedback to inform the machine learning module 702 and/or the artificial intelligence module 703 on how to improve at generating neural embeddings 704 that more closely match the underlying semantic meaning of the data.

In addition to the method described above, a corresponding system may include several modules stored in memory that perform steps including accessing portions of data, and accessing neural embeddings, where the neural embeddings are configured to encode semantic information associated with the accessed data into numeric values. The modules may further apply locality sensitive hashing to the accessed neural embeddings to assign data portions encoded within a specified numerical range to a cluster of related data items, and to assign data portions outside of the specified numerical range to a cluster of unrelated data items. The modules may also perform at least one data management operation on the accessed data according to the clustering resulting from the locality sensitive hashing.

Additionally or alternatively, in some embodiments, the above-described method may be encoded as computer-readable instructions on a computer-readable medium. For example, a computer-readable medium may include one or more computer-executable instructions that, when executed by at least one processor of a computing device, may cause the computing device to access portions of data, and access neural embeddings, where the neural embeddings are configured to encode semantic information associated with the accessed data into numeric values. The instructions may further apply locality sensitive hashing to the accessed neural embeddings to assign data portions encoded within a specified numerical range to a cluster of related data items, and to assign data portions outside of the specified numerical range to a cluster of unrelated data items. The instructions may also perform at least one data management operation on the accessed data according to the clustering resulting from the locality sensitive hashing.

Accordingly, methods and systems are provided in which data management operations are facilitated using neural embeddings and locality sensitive hashing. The combination of neural embeddings that group potentially dissimilar items together based on semantic meaning, and clustering certain items together according to locality sensitive hashing provides enhanced speed benefits that, at least in some cases, scale logarithmically with the amount of data being operated on. The embodiments described herein may work with a variety of different types of data, and may include many different data management operations, either performed alone or in combination with each other.

### EXAMPLE EMBODIMENTS

1. A computer-implemented method comprising: accessing one or more portions of data, accessing one or more neural embeddings, the neural embeddings being configured to encode semantic information associated with the accessed data into numeric values, applying locality sensitive hashing to the accessed neural embeddings to assign data portions encoded within a specified numerical range to a cluster of related data items, and to assign data portions outside of the specified numerical range to a cluster of unrelated data items, and performing at least one data management operation on the accessed data according to the clustering resulting from the locality sensitive hashing.

2. The computer-implemented method of claim 1, wherein the data management operation comprises a diff operation that identifies differences in the one or more portions of data.

3. The computer-implemented method of claim 2, wherein the one or more portions of data comprise one or more log files, and wherein the diff operation is performed on the one or more log files.

4. The computer-implemented method of claim 3, wherein the one or more log files include a plurality of words or phrases, and wherein the neural embeddings encode semantic information associated with the words or phrases into a numerical representation associated with each word or phrase.

5. The computer-implemented method of claim 1, wherein the data management operation comprises a search operation that searches the one or more portions of data for specified data.

6. The computer-implemented method of claim 5, wherein the search operation is performed using the clustering resulting from the locality sensitive hashing, such that data items in the cluster of related data items are searched prior to searching data items in the cluster of unrelated data items.

7. The computer-implemented method of claim 1, wherein the data management operation comprises a deduplication operation that removes duplicate information from the one or more portions of data.

8. The computer-implemented method of claim 7, wherein the deduplication operation is performed using the clustering resulting from the locality sensitive hashing, such that data items in the cluster of related data items are removed, and data items in the cluster of unrelated data items are maintained.

9. The computer-implemented method of claim 1, wherein the one or more portions of data comprise at least one of image data, video data, audio data, or textual data.

10. The computer-implemented method of claim 1, further comprising generating the one or more neural embeddings that are accessed for the application of locality sensitive hashing.

11. The computer-implemented method of claim 10, wherein the neural embeddings are generated by a communicatively linked neural network.

12. A system comprising: at least one physical processor and physical memory comprising computer-executable instructions that, when executed by the physical processor, cause the physical processor to: access one or more portions of data, access one or more neural embeddings, the neural embeddings being configured to encode semantic information associated with the accessed data into numeric values, apply locality sensitive hashing to the accessed neural embeddings to assign data portions encoded within a specified numerical range to a cluster of related data items, and to assign data portions outside of the specified numerical range to a cluster of unrelated data items, and perform at least one data management operation on the accessed data according to the clustering resulting from the locality sensitive hashing.

13. The system of claim 12, wherein the data management operation comprises exception monitoring configured to monitor for and identify anomalous occurrences.

14. The system of claim 13, wherein the exception monitoring is performed using the clustering resulting from the locality sensitive hashing, such that data items in the cluster of unrelated data items are identified as potential exceptions.

15. The system of claim 12, wherein the data management operation comprises event detection which determines when specified events have occurred.

16. The system of claim 15, wherein the event detection is performed using the clustering resulting from the locality sensitive hashing, such that data items in the cluster of related data items are grouped together as part of a specified event.

17. The system of claim 12, wherein the data management operation performed on the accessed data comprises updating a neural embedding model used to generate the one or more neural embeddings.

18. The system of claim 17, wherein the embedding model is continually updated over time based on feedback derived from the locality sensitive hashing clustering.

19. The system of claim 12, wherein the data management operation comprises performing a substantially constant time semantic search on a dataset of at least a threshold minimum size.

20. A non-transitory computer-readable medium comprising one or more computer-executable instructions that, when executed by at least one processor of a computing device, cause the computing device to: access one or more portions of data, access one or more neural embeddings, the neural embeddings being configured to encode semantic information associated with the accessed data into numeric values, apply locality sensitive hashing to the accessed neural embeddings to assign data portions encoded within a specified numerical range to a cluster of related data items, and to assign data portions outside of the specified numerical range to a cluster of unrelated data items, and perform at least one data management operation on the accessed data according to the clustering resulting from the locality sensitive hashing.

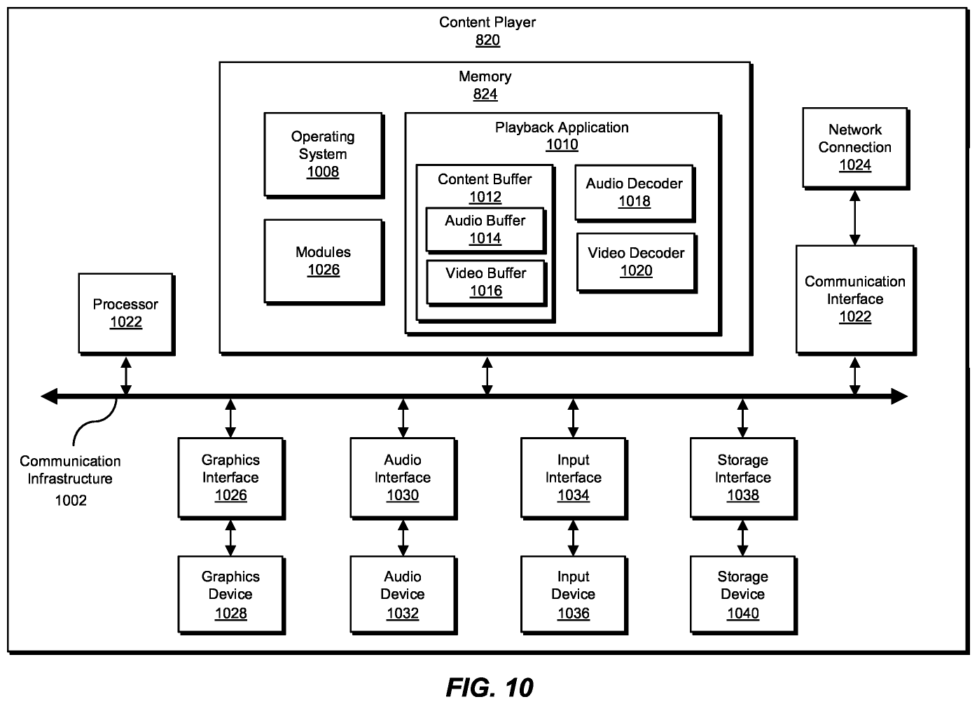

The following will provide, with reference to FIG. 8, detailed descriptions of exemplary ecosystems in which content is provisioned to end nodes and in which requests for content are steered to specific end nodes. The discussion corresponding to FIGS. 10 and 11 presents an overview of an exemplary distribution infrastructure and an exemplary content player used during playback sessions, respectively. These exemplary ecosystems and distribution infrastructures are implemented in any of the embodiments described above with reference to FIGS. 1-7.

FIG. 8 is a block diagram of a content distribution ecosystem 800 that includes a distribution infrastructure 810 in communication with a content player 820. In some embodiments, distribution infrastructure 810 is configured to encode data at a specific data rate and to transfer the encoded data to content player 820. Content player 820 is configured to receive the encoded data via distribution infrastructure 810 and to decode the data for playback to a user. The data provided by distribution infrastructure 810 includes, for example, audio, video, text, images, animations, interactive content, haptic data, virtual or augmented reality data, location data, gaming data, or any other type of data that is provided via streaming.

Distribution infrastructure 810 generally represents any services, hardware, software, or other infrastructure components configured to deliver content to end users. For example, distribution infrastructure 810 includes content aggregation systems, media transcoding and packaging services, network components, and/or a variety of other types of hardware and software. In some cases, distribution infrastructure 810 is implemented as a highly complex distribution system, a single media server or device, or anything in between. In some examples, regardless of size or complexity, distribution infrastructure 810 includes at least one physical processor 812 and at least one memory device 814. One or more modules 816 are stored or loaded into memory 814 to enable adaptive streaming, as discussed herein.

Content player 820 generally represents any type or form of device or system capable of playing audio and/or video content that has been provided over distribution infrastructure 810. Examples of content player 820 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 810, content player 820 includes a physical processor 822, memory 824, and one or more modules 826. Some or all of the adaptive streaming processes described herein is performed or enabled by modules 826, and in some examples, modules 816 of distribution infrastructure 810 coordinate with modules 826 of content player 820 to provide adaptive streaming of digital content.

In certain embodiments, one or more of modules 816 and/or 826 in FIG. 8 represent one or more software applications or programs that, when executed by a computing device, cause the computing device to perform one or more tasks. For example, and as will be described in greater detail below, one or more of modules 816 and 826 represent modules stored and configured to run on one or more general-purpose computing devices. One or more of modules 816 and 826 in FIG. 8 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 812 and 822 generally represent any type or form of hardware-implemented processing unit capable of interpreting and/or executing computer-readable instructions. In one example, physical processors 812 and 822 access and/or modify one or more of modules 816 and 826, respectively. Additionally or alternatively, physical processors 812 and 822 execute one or more of modules 816 and 826 to facilitate adaptive streaming of digital content. Examples of physical processors 812 and 822 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 814 and 824 generally represent any type or form of volatile or non-volatile storage device or medium capable of storing data and/or computer-readable instructions. In one example, memory 814 and/or 824 stores, loads, and/or maintains one or more of modules 816 and 826. Examples of memory 814 and/or 824 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

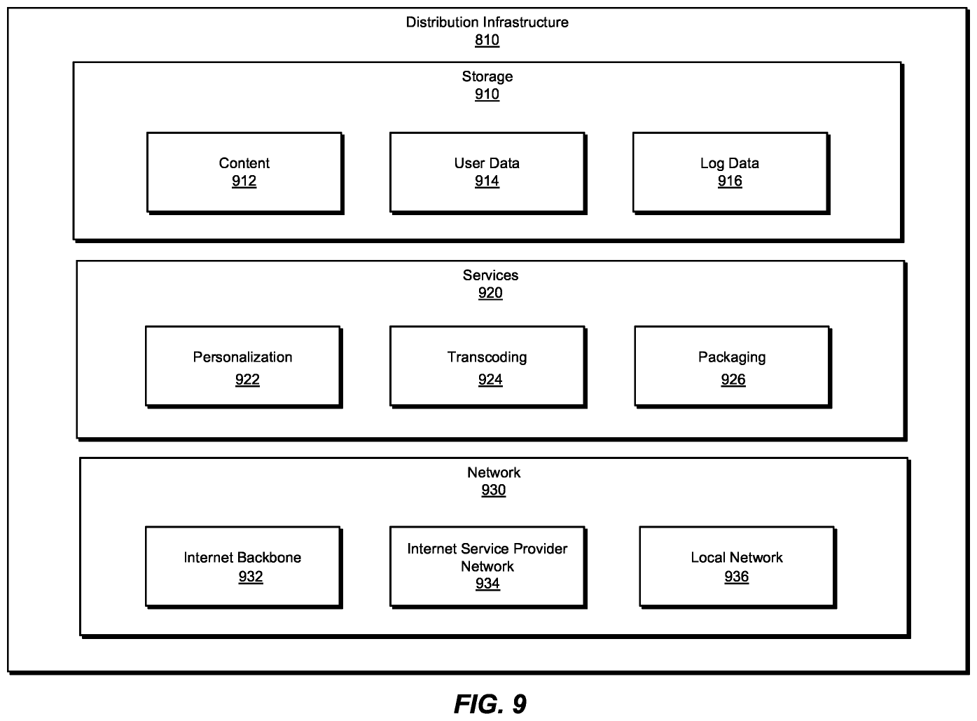

FIG. 9 is a block diagram of exemplary components of content distribution infrastructure 810 according to certain embodiments. Distribution infrastructure 810 includes storage 910, services 920, and a network 930. Storage 910 generally represents any device, set of devices, and/or systems capable of storing content for delivery to end users. Storage 910 includes a central repository with devices capable of storing terabytes or petabytes of data and/or includes distributed storage systems (e.g., appliances that mirror or cache content at Internet interconnect locations to provide faster access to the mirrored content within certain regions). Storage 910 is also configured in any other suitable manner.

As shown, storage 910 may store a variety of different items including content 912, user data 914, and/or log data 916. Content 912 includes television shows, movies, video games, user-generated content, and/or any other suitable type or form of content. User data 914 includes personally identifiable information (PII), payment information, preference settings, language and accessibility settings, and/or any other information associated with a particular user or content player. Log data 916 includes viewing history information, network throughput information, and/or any other metrics associated with a user's connection to or interactions with distribution infrastructure 810.

Services 920 includes personalization services 922, transcoding services 924, and/or packaging services 926. Personalization services 922 personalize recommendations, content streams, and/or other aspects of a user's experience with distribution infrastructure 810. Encoding services 924 compress media at different bitrates which, as described in greater detail below, enable real-time switching between different encodings. Packaging services 926 package encoded video before deploying it to a delivery network, such as network 930, for streaming.

Network 930 generally represents any medium or architecture capable of facilitating communication or data transfer. Network 930 facilitates communication or data transfer using wireless and/or wired connections. Examples of network 930 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 9, network 930 includes an Internet backbone 932, an internet service provider 934, and/or a local network 936. As discussed in greater detail below, bandwidth limitations and bottlenecks within one or more of these network segments triggers video and/or audio bit rate adjustments.

FIG. 10 is a block diagram of an exemplary implementation of content player 820 of FIG. 8. Content player 820 generally represents any type or form of computing device capable of reading computer-executable instructions. Content player 820 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 10, in addition to processor 822 and memory 824, content player 820 includes a communication infrastructure 1002 and a communication interface 1022 coupled to a network connection 1024. Content player 820 also includes a graphics interface 1026 coupled to a graphics device 1028, an input interface 1034 coupled to an input device 1036, and a storage interface 1038 coupled to a storage device 1040.

Communication infrastructure 1002 generally represents any type or form of infrastructure capable of facilitating communication between one or more components of a computing device. Examples of communication infrastructure 1002 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 824 generally represents any type or form of volatile or non-volatile storage device or medium capable of storing data and/or other computer-readable instructions. In some examples, memory 824 stores and/or loads an operating system 1008 for execution by processor 822. In one example, operating system 1008 includes and/or represents software that manages computer hardware and software resources and/or provides common services to computer programs and/or applications on content player 820.

Operating system 1008 performs various system management functions, such as managing hardware components (e.g., graphics interface 1026, audio interface 1030, input interface 1034, and/or storage interface 1038). Operating system 1008 also provides process and memory management models for playback application 1010. The modules of playback application 1010 includes, for example, a content buffer 1012, an audio decoder 1018, and a video decoder 1020.

Playback application 1010 is configured to retrieve digital content via communication interface 1022 and play the digital content through graphics interface 1026. Graphics interface 1026 is configured to transmit a rendered video signal to graphics device 1028. In normal operation, playback application 1010 receives a request from a user to play a specific title or specific content. Playback application 1010 then identifies one or more encoded video and audio streams associated with the requested title. After playback application 1010 has located the encoded streams associated with the requested title, playback application 1010 downloads sequence header indices associated with each encoded stream associated with the requested title from distribution infrastructure 810. A sequence header index associated with encoded content includes information related to the encoded sequence of data included in the encoded content.

In one embodiment, playback application 1010 begins downloading the content associated with the requested title by downloading sequence data encoded to the lowest audio and/or video playback bitrates to minimize startup time for playback. The requested digital content file is then downloaded into content buffer 1012, which is configured to serve as a first-in, first-out queue. In one embodiment, each unit of downloaded data includes a unit of video data or a unit of audio data. As units of video data associated with the requested digital content file are downloaded to the content player 820, the units of video data are pushed into the content buffer 1012. Similarly, as units of audio data associated with the requested digital content file are downloaded to the content player 820, the units of audio data are pushed into the content buffer 1012. In one embodiment, the units of video data are stored in video buffer 1016 within content buffer 1012 and the units of audio data are stored in audio buffer 1014 of content buffer 1012.

A video decoder 1020 reads units of video data from video buffer 1016 and outputs the units of video data in a sequence of video frames corresponding in duration to the fixed span of playback time. Reading a unit of video data from video buffer 1016 effectively de-queues the unit of video data from video buffer 1016. The sequence of video frames is then rendered by graphics interface 1026 and transmitted to graphics device 1028 to be displayed to a user.

An audio decoder 1018 reads units of audio data from audio buffer 1014 and outputs the units of audio data as a sequence of audio samples, generally synchronized in time with a sequence of decoded video frames. In one embodiment, the sequence of audio samples is transmitted to audio interface 1030, which converts the sequence of audio samples into an electrical audio signal. The electrical audio signal is then transmitted to a speaker of audio device 1032, which, in response, generates an acoustic output.

In situations where the bandwidth of distribution infrastructure 810 is limited and/or variable, playback application 1010 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1026 is configured to generate frames of video data and transmit the frames of video data to graphics device 1028. In one embodiment, graphics interface 1026 is included as part of an integrated circuit, along with processor 822. Alternatively, graphics interface 1026 is configured as a hardware accelerator that is distinct from (i.e., is not integrated within) a chipset that includes processor 822.

Graphics interface 1026 generally represents any type or form of device configured to forward images for display on graphics device 1028. For example, graphics device 1028 is fabricated using liquid crystal display (LCD) technology, cathode-ray technology, and light-emitting diode (LED) display technology (either organic or inorganic). In some embodiments, graphics device 1028 also includes a virtual reality display and/or an augmented reality display. Graphics device 1028 includes any technically feasible means for generating an image for display. In other words, graphics device 1028 generally represents any type or form of device capable of visually displaying information forwarded by graphics interface 1026.

As illustrated in FIG. 10, content player 820 also includes at least one input device 1036 coupled to communication infrastructure 1002 via input interface 1034. Input device 1036 generally represents any type or form of computing device capable of providing input, either computer or human generated, to content player 820. Examples of input device 1036 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 820 also includes a storage device 1040 coupled to communication infrastructure 1002 via a storage interface 1038. Storage device 1040 generally represents any type or form of storage device or medium capable of storing data and/or other computer-readable instructions. For example, storage device 1040 is a magnetic disk drive, a solid-state drive, an optical disk drive, a flash drive, or the like. Storage interface 1038 generally represents any type or form of interface or device for transferring data between storage device 1040 and other components of content player 820

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed, transform the data, output a result of the transformation to generate neural embeddings, use the result of the transformation to apply locality sensitive hashing, and store the result of the transformation to perform at least one data management operation. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
accessing one or more portions of data;
accessing one or more neural embeddings, the neural embeddings being configured to encode semantic information associated with the accessed data into numeric values;
applying locality sensitive hashing to the accessed neural embeddings to assign data portions encoded within a specified numerical range to a cluster of related data items, and to assign data portions outside of the specified numerical range to a cluster of unrelated data items; and
performing at least one data management operation on the accessed data according to the clustering resulting from the locality sensitive hashing.

2. The computer-implemented method of claim 1, wherein the data management operation comprises a diff operation that identifies differences in the one or more portions of data.

3. The computer-implemented method of claim 2, wherein the one or more portions of data comprise one or more log files, and wherein the diff operation is performed on the one or more log files.

4. The computer-implemented method of claim 3, wherein the one or more log files include a plurality of words or phrases, and wherein the neural embeddings encode semantic information associated with the words or phrases into a numerical representation associated with each word or phrase.

5. The computer-implemented method of claim 1, wherein the data management operation comprises a search operation that searches the one or more portions of data for specified data.

6. The computer-implemented method of claim 5, wherein the search operation is performed using the clustering resulting from the locality sensitive hashing, such that data items in the cluster of related data items are searched prior to searching data items in the cluster of unrelated data items.

7. The computer-implemented method of claim 1, wherein the data management operation comprises a deduplication operation that removes duplicate information from the one or more portions of data.

8. The computer-implemented method of claim 7, wherein the deduplication operation is performed using the clustering resulting from the locality sensitive hashing, such that data items in the cluster of related data items are removed, and data items in the cluster of unrelated data items are maintained.

9. The computer-implemented method of claim 1, wherein the one or more portions of data comprise at least one of image data, video data, audio data, or textual data.

10. The computer-implemented method of claim 1, further comprising generating the one or more neural embeddings that are accessed for the application of locality sensitive hashing.

11. The computer-implemented method of claim 10, wherein the neural embeddings are generated by a communicatively linked neural network.

12. A system comprising:
at least one physical processor; and
physical memory comprising computer-executable instructions that, when executed by the physical processor, cause the physical processor to:
access one or more portions of data;
access one or more neural embeddings, the neural embeddings being configured to encode semantic information associated with the accessed data into numeric values;
apply locality sensitive hashing to the accessed neural embeddings to assign data portions encoded within a specified numerical range to a cluster of related data items, and to assign data portions outside of the specified numerical range to a cluster of unrelated data items; and
perform at least one data management operation on the accessed data according to the clustering resulting from the locality sensitive hashing.

13. The system of claim 12, wherein the data management operation comprises exception monitoring configured to monitor for and identify anomalous occurrences.

14. The system of claim 13, wherein the exception monitoring is performed using the clustering resulting from the locality sensitive hashing, such that data items in the cluster of unrelated data items are identified as potential exceptions.

15. The system of claim 12, wherein the data management operation comprises event detection which determines when specified events have occurred.

16. The system of claim 15, wherein the event detection is performed using the clustering resulting from the locality sensitive hashing, such that data items in the cluster of related data items are grouped together as part of a specified event.

17. The system of claim 12, wherein the data management operation performed on the accessed data comprises updating a neural embedding model used to generate the one or more neural embeddings.

18. The system of claim 17, wherein the embedding model is continually updated over time based on feedback derived from the locality sensitive hashing clustering.

19. The system of claim 12, wherein the data management operation comprises performing a substantially constant time semantic search on a dataset of at least a threshold minimum size.

20. A non-transitory computer-readable medium comprising one or more computer-executable instructions that, when executed by at least one processor of a computing device, cause the computing device to:
access one or more portions of data;
access one or more neural embeddings, the neural embeddings being configured to encode semantic information associated with the accessed data into numeric values;
apply locality sensitive hashing to the accessed neural embeddings to assign data portions encoded within a specified numerical range to a cluster of related data items, and to assign data portions outside of the specified numerical range to a cluster of unrelated data items; and
perform at least one data management operation on the accessed data according to the clustering resulting from the locality sensitive hashing.
